(19) United States
(12) Patent Application Publication
(10) Pub. No.: US 2006/0084502 A1
(43) Pub. Date: Apr. 20, 2006

(54) Thin client user interface for gaming systems

(75) Inventors: Justin G. Downs III, Henderson, NV (US); Oliver M. Schubert, Las Vegas, NV (US); Atilla Grauzer, Las Vegas, NV (US)

Correspondence Address: Mark A. Litman & Associates, P.A.;York Business Center, Suite 205, 3209 West 76th St., Edina, MN, 55435, US

(73) Assignee: Shuffle Master, Inc.

(21) Appl. No.: 10/957,537

(22) Filed: Oct. 1, 2004

(51) Int. Cl. A63F 13/00

(52) U.S. Cl. 463/29

(57) ABSTRACT

An access system enables casino personnel to access casino information from a casino computer through a network accessible display device that contains a web browser. The access system comprises a thin client user interface server. Information provided to the casino computer can be requested from multiple files and provided in customized formats or from among numerous available formats at the request of the casino personnel. The request can be configured and responded to according to such diverse information requests as data/records specific to personnel (e.g., dealers, pit bosses, croupier, security guards, etc.), specific tables, specific games, specific classes of games, pits, wagering limits, shufflers, roulette wheels, and the like, and the requests can define bases of information such as performance, down time, volume, frequency, and individual round events (e.g., hands in cards or spins in roulette or tosses in craps), and the requests can be tailored on casino personnel input to specific time intervals or histories. Special software is not needed at the user side of the thin client user interface to access the database.

### BACKGROUND OF THE INVENTION

1. Field of the Invention

The present invention relates to the field of casino games, and particularly casino table games. A system is provided wherein casino personnel are able to access and interface with information located on a central or local table positional computer using a network accessible terminal. The information accessed may relate to casino personnel performance, player performance, equipment performance, game activity, location activity, gaming events, gaming activity, and any other form of event within a casino that can be recorded as data.

2. Background of the Art

The casino environment has become much more technically sophisticated with respect to gaming security over the years. Monitoring of the casino environment has progressed from visual observation by staff, to chip reading, electromechanical or optical card reading, camera monitoring, bet sensing and the like to a level where the available information can begin to exceed the ability of casino personnel to address the volume of information with great success.

Published U.S. Patent Application No. 2004/0176975 describes an integrated casino and hotel management control system comprising, a user management server for managing a user of a casino and a hotel, a game server for managing services related to games, a communication network for interconnecting the user management server and the game server, and a portable terminal connected to the user management server and the game server through the communication network, wherein the user management server and the game server provide services of the casino and the hotel through the communication network and the portable terminal. In another aspect, this Patent Publication describes an integrated casino and hotel management system having, a user management server for managing a user of a casino and a hotel, a game server for managing services related to games, a communication network for interconnecting the user management server and the game server, and a portable terminal connected to the user management server and the game server through the communication network, wherein the user management server and the game server provide services of the casino and the hotel through the communication network and the portable terminal, a hotel facility to be used by the user, the use being managed by the user management server; and a casino for the user to play games in, the services related to the games being managed by the game server. FIG. 2 of that publication shows a configuration for certain elements of the hardware such an integrated system server 10 as an integrated service providing means that allows servers (a hotel server 11, a house card server 12, a service server 13, an intra-service server 14, a collection/analysis server 15, a casino deposit server 16, a PTS server 17, a multimedia server 18) to cooperate according to a unique ID recorded on a single integrated card given to the user at the time of checking in. Here, the integrated system server 10 is comprised of a user management server 10a and a game server 10b. The user management sever 10a is comprised of hotel server 11, house card server 12, service server 13 and intra-service server 14. The game server 10b is comprised of collection/analysis server 15, casino deposit server 16, PTS server 17 and multimedia server 18.

Published U.S. Patent Application No. 2004/0142750 describes an in-house and on-line gaming web site 125. Web site 125 offers Internet gaming similar to that offered in-house at a casino 105, but without using the physical devices available in-house. For example, web site 125 might offer on-line versions of slot machine game 130 or blackjack game 135. The credits used by the player in Internet gaming can come from any desired source. For example, the player can input a credit card number to web site 125, which then issues the player a number of credits in exchange for a charge to the player's credit card. Or the player can use credits associated with the player's account. Systems for transferring credits from a player's account to a gaming device are described in U.S. patent application Ser. No. 09/134,285, filed Aug. 14, 1998, now pending, and U.S. patent application Ser. No. 09/694,065, filed Nov. 19, 2000, now pending, which are hereby incorporated by reference. A person skilled in the art will recognize how the systems can be modified to transfer credits to a web site offering Internet gaming. To use web site 125, a user connects to web site 125 from a computer, such as computer system 140, across network 145. Computer system 140 conventionally includes computer 145, monitor 150, keyboard 155, and mouse 160. A person skilled in the art will recognize that although computer system 140 is shown as a desktop personal computer, the invention is not limited to any specific type of computer. For example, computer system 140 can also be an Internet appliance, with monitor 150, keyboard 155, and mouse 160 integrated into the housing of computer 145. Computer system 140 can also take other forms: for example, a personal digital assistant (PDA) or other handheld device, or even a cellular telephone. Optional equipment not shown as part of computer system 140 in FIG. 1A are other input/output devices, such as a printer. Also not shown in FIG. 1A are the conventional internal components of computer system 140: e.g., a central processing unit, memory, file system, etc. Similarly, network 145 can be any variety of networks, such as a local area network (LAN), wide area network (WAN), wireless network, or global network (such as the Internet), among others. Network 145 can also be any combination of the above networks used to connect computer system 140 and web site 125. Even if casino 105 does not own or operate server 150, casino 105 will want to be able to track the player's activity on web site 125. To enable this tracking, server 150 can report the player's activities to casino 150. Connection 155 enables server 150 to report a player's activities to casino 105. A person skilled in the art will recognize that connection 155 does not have to be a direct physical connection. Instead, server 150 can connect to casino 105 via network 145. Statistically significant data for a player can be shown on a display screen. Each column on a screen may store information about various trips the player has made to the casino, and each row stores a particular type of data. For example, the column titled “Current Trip” stores data generated by the player during his current play at the casino. Similarly, the columns titled “Avg. Day,” “MTD” (Month to Date), and “YTD” (Year to Date) storage data about the player's average day, month to date, and year to date, respectively, activity at the casino. Some of the data shown include the player's coin in to the slot machines, the player's coin out (that is, amount received back from the slot machines), any jackpots won, the casino's actual profits from the player (before factoring in any comps the player has received), the casino's theoretical profits from the player (after factoring in comps), and so on. A screen may also show statistics about the player over his entire lifetime. In addition, the information shown on screen 615 can include statistics generated by all players linked to an individual account or just a subset of players, can include all properties owned by the casino or just a subset of properties, can be limited to specific revenue sources (for example, just slot machines or just table games), etc. For example, the casino can calculate how close a player is to receiving a comp from the casino. As with FIG. 6B, monitor 605 is not shown in FIG. 6C. For example, in screen 620 the casino can see statistics from the player's current trip. To determine how close the player is to receiving a comp, the casino can enter the desired comp in shaded area 625. The system can then determine whether the player is entitled to the comp, and if not, how much additional activity the player will need before being entitled to the comp. By using screen 620, the casino can consider “what if” scenarios with the player.

Published U.S. Patent Application No. 2004/0087362 describes a table game system including a position system that generates position data, such as the positions of one or more players and the value of cards, dice, roulette wheels, or other game table positions. A wager system generates wager data, such as the wager placed by each player at each position. A payout system receives the position data and the wager data and generates payout data, such as by using the position data to determine the outcome of the table game and the wager data to determine the payout data based on the outcome of the table game. The system enables maintenance of player's account, average bet, buy-in amounts, time-in, time-out and win/loss information. The method in use for rating players at table games requires handwritten forms to be manually entered into a database. This method of data acquisition is inefficient and inherently prone to error, and it is typical for this process to be accomplished through multiple personnel. This historical method of data acquisition is also inaccurate because dollar transactions below $100 are generally ignored because of the transaction costs required to monitor these small transactions, which presents certain opportunities for breaches in security as well. Casinos are also required by law to monitor and report transactions above certain thresholds. This legal requirement often requires a casino to rate unknown players. As an unknown player moves between table games, rating and/or establishing when the player has reached a particular threshold becomes increasingly difficult. Security cameras that are typically mounted in the ceiling of a casino are sometimes used to help resolve this issue. However, these cameras are elevated and usually oriented at an exterior orientation to the table game. They are also not dedicated to securing photographic records for positive identifications of players, but rather are provided to allow security personnel to make identifications, making it difficult to validate ratings. Casino personnel are enabled to reconstruct a session of play for a table game electronically where there is a discrepancy in wagering, payout or hand interpretation (i.e., a dealer takes or pays a bet incorrectly). In these situations, a supervisor can replicate the session by taking the cards from the discard rack manually or using an electronic reconstruction of the hand and redistributing the physical cards or electronic representations to the players according to the rules of the game.

Published U.S. patent application Ser. No. 0029087 describes a training and management system for use at a casino-wagering environment. The system may comprises standard hardware and software technology programmed according to the described procedures to educate the user (which may be casino personnel) on both the standard play and alternative strategies for various games of chance, and to encourage ongoing development and retention of gaming skills. Unique programs can be devised and executed for any game offered by the system administrator including blackjack, roulette, baccarat, poker, craps, slot machines, and the like. Training programs can take many forms including standardized tests, simulated game play, simulated dealer play, tutorial play, competitive play, and entertainment play. When timing and scoring are included in the training, the trainee is encouraged to hone the skills of the game at greater speeds and greater proficiency. The form of the user interface for the training block is not essential to the system. The user interface may be comprised of input by keyboard, mouse, trackball, pen, stylus, touch screen, voice command, remote control, IR device, any combination of the above, or any other input methods as are known in the art. The function of the scoring block is to monitor and record data relating to the results of any scored exercise initiated in any of the other program blocks. Scoring may include a variety of measured values including time, accuracy, quantity, historical trends, currency, comparative performance, threshold performance, incentive based credits, statistical functions and other variables as are known in the art. Data handled in the scoring block can be locally or remotely stored, transmitted or retrieved by the variety of manual, electronic and wireless techniques as are known in the art. The function of the administrative block is to send, receive, edit and store the input and output of the other program blocks. Typically, access to the administrative block is restricted (preferably through the user identification block) by key, password, magnetic swipe, biometric sensor or other secure authorization means. The administrative block may include subroutines for creating, editing and deleting user data; human resources applications, viewing and manipulating scoring data; creating and editing content for the communication and training blocks; basic electronic file management functions and other system management and maintenance tasks as are known in the art.

U.S. Pat. No. 6,676,517 (Beavers) describes a table game system that includes a position system that generates position data, such as the positions of one or more players and the value of cards, dice, roulette wheels, or other game table positions. A wager system generates wager data, such as the wager placed by each player at each position. A payout system receives the position data and the wager data and generates payout data, such as by using the position data to determine the outcome of the table game and the wager data to determine the payout data based on the outcome of the table game. FIGS. 13A and 13B of this publication are a system 45 for generating card status data in accordance with an exemplary embodiment of the described invention. In one embodiment, system 45 includes card recognition system 45A, which is configured to be slid onto or otherwise mounted with a shoe 45B or other suitable card dispensing systems or apparatuses. Card recognition system 45A includes an enclosure, a burn control 45.04, a hold card reveal control 45.05, an include control 45.06, an indicator 45.07 and an imaging sensor 45.02. The imaging sensor 45.02 is oriented so that card image data can be acquired as a card is drawn from the shoe 45B. Shoe 45B can include a battery 45.03, photoelectric cell 45.15 or other suitable power source, to supply power to the card recognition system 45A. Shoe 45B can further include a shuttle 45.01 and shuttle guide 45.09, which are configured to generate card deck data. In one exemplary embodiment, shuttle 45.01 can be weighted and include a wheel and sensor-type contact that allows the approximate number of cards in the deck to be assessed. In another exemplary embodiment, imaging sensor 45.02 can be a contact image sensor (CIS), model number PI216MC-DR, available from Peripheral Imaging Corporation of San Jose, Calif. or a CMOS linear photo diode array (PDA), that can allow an independent light source to be omitted, or can be other suitable devices or systems. In other exemplary embodiment, system 45 can also be configured in the table surface, with a shuffle machine (such as one that shuffles two decks and deals cards, one that deals cards in a random order, or other suitable shuffle machines), or in other suitable locations. A wheel device 45.99 can be used to generate card coordinate data, such as a wheel device in proximity to the withdraw slot 45.08, and the card coordinate data can be used in a suitable embodiment, such as where the imaging sensor 45.02 is used with a shuffle machine or is embedded in the table. In this manner, data pertaining to whether or not a card was drawn, the exact value of the card that was drawn or other suitable data can be stored. Likewise, controls such as a burn control 45.04 generating burn data (such as to ignore the last card or next card that is drawn), a hold card reveal control 45.05 generating hold card reveal data, and include control 45.06 generating player include data (for including players after initiation of play), or other suitable controls can be used to allow the dealer to indicate the status of a drawn card. A reveal indicator 45.07 can also indicate to the dealer when the dealer's facedown card in a game of black jack is an ace and if the dealer's face-up card has a value of ten, so as to save the time it would normally take to complete a session of blackjack when the dealer has already won. Activation of the hold card reveal control 45.05 can be performed by a suitable system when the dealer has a card with a value of ten showing, or other suitable procedures can be used.

U.S. Pat. No. 6,446,864 (Kim) describes a system for automatically monitoring and tracking dealers located at gaming tables in a gaming facility using a wireless communication network, the system comprising: a portable data-carrying device; a table module provided near the dealer on the gaming table, the table module including a plurality of call buttons, a chip sensing mechanism, a reading unit and a signal processing means, for generating service call data, dealer-associated data and chip-associated data, wherein each chip has an unique color representing a denomination thereof; means connected to the table module via the network, for receiving two types of the data generated from the table module, storing them in a first and second databases, determining the performance of the dealer and estimating a revenue of the gaming facility, based on the stored data; and means connected to the table module via the network, for receiving the remaining type of the data generated from the table module, and displaying same on a screen. The reading means reads out an identification code of the dealer contained in the portable data carrying device; and the signal processing means processes the service call data, the dealer-associated data and the chip-associated data, stores them in a memory and transmits the same via the network.

U.S. Pat. No. 6,302,793 (Pertitta et al.) describes a player tracking system and method for tracking the play of a customer playing wagering games at any one of a plurality of gaming venues. The system and method includes a local database for each venue and a central database. In response to reading a player tracking card the player's file at the local database is placed into an open condition to receive updated gaming information. When the player terminates their gaming session, gaming activity data is sent to the player's file at the local database and as network data to the central database as well as other venue local databases to maintain a current record of gaming information throughout the system for the purposes of tracking wagering activity and providing promotions to the player based, at least in part, on that wagering activity. The system comprises (i) a card issued to each player at one of the locations defining a player home location, each card including a machine readable element including card data corresponding to an account number assigned to the player; (ii) a local data structure including a local database for each location, the local database including a home location data structure including a player account including home location data including: (a) a player account number, (b) player identification data, (c) player account data relating to the player's wagering activity, and (d) player personal and credit data, the local data structure for non-home locations including network data including, for each player, network account data, the network data including player account number and wagering activity data. There are also (iii) means associated with each game for reading the machine readable element of a card and creating card data signals corresponding to the card data when the card is present; (iv) a network data link to transmit the card data signals to the local database corresponding to the player's gaming location to, from the card data, locate the player's local database network account and place it in an open condition when the card is presented at the reading means and to close the account when the card is no longer presented; (v) means for allocating data corresponding to wagering activity of the player to the player's local network account during the period the player's account is in the open condition; (vi) a central database, the central database including a player data structure including, for each player issued a card at any location, the player account network data; (vii) a network data link between the local databases and the central database; (viii) means responsive to closure of the player's account at the gaming location local database for sending data signals to the central database over the network data link to (a) open the player's network account at the central database, (b) allocate the player's wagering activity data to the player's network account at the central database and at the local databases at the non-home locations to reflect new wagering activity data, whereby the home, local and central databases contain updated wagering data, and (c) close the central and non-home location player accounts; (ix) wherein the local and central data structures for each player account contain personal, progressive, bonus data representing an amount of a personal bonus to be awarded to the player in the event that he obtains a designated bonus outcome at the game; and (x) means for allocating at least a portion of wagers made by each player as personal bonus data to the player's account to progressively increase the amount reflected as the personal bonus.

U.S. Pat. No. 5,770,533 (Franchi) describes a casino operating system for controlling the flow of funds and monitoring gambling activities in a casino or a gaming establishment utilizing a network of computers, including a central computer and individual game computers. Each player receives an encoded betting card from the cashier. At the games, each player position is equipped with a control panel including a card reader into which the betting card is inserted. The control panel also includes an electronic screen and keyboard. From the control panel, the player may place a bet and perform all options available to the player in the particular game. The system records the hands dealt to each player and the winner, and credits or debits the player's betting card accordingly. In an alternative embodiment, the casino operating system allows the players to use chips to place bets instead of the above-described betting card. The chips are marked or encoded so that they can be counted once final bets have been placed to determine the amount of each player's bet. In games requiring the placement of bets in certain positions on the gaming table, each player may be provided with a betting marker used to indicate the position of his bets on the table. A touch-sensitive screen maybe used whereby bets are placed by touching the desired position on the screen, or a two-way remote control console for placing bets may alternatively be used.

Casino Table Games (such as blackjack, poker, poker variants such as Let It Ride® poker, Three Card Poker® and Four Card Poker®, baccarat, Casino War® game, also require some security control, and more highly automated systems are being described in the literature and introduced to the marketplace. There are, for example, numerous U.S. Patents assigned to MindPlay LLC (e.g., U.S. Pat. Nos. 6,688,979; 6,685,568; 6,663,490; 6,652,379; 6,638,161; 6,595,857; 6,579,181; 6,579,180; 6,533,662; 6,530,837; 6,530,836; 6,527,271; 6,520,857; 6,517,436; 6,517,435; and 6,460,848) that describe systems and components of systems that are used to more fully automate casino table card games, and especially blackjack. These systems include card recognition devices, bet sensing devices (e.g., chip sensors and counters), software to evaluate the games as and after they are played, and the like. One feature of the MindPlay system is a central processor.

U.S. Pat. No. 6,165,069 (Sines et al.) describe systems for playing virtual casino table card games. The systems include a presentation unit, which has video displays, which portray virtual playing cards and other information at gaming tables attended by live participants. Shuffling, cutting, dealing and return of playing cards are accomplished using data processing functions within an electronic game processor or processors, which enable these functions to be performed quickly and without manual manipulation of playing cards. The invention allows casinos to speed play and reduce the risk of cheating while maintaining the attractive ambiance of a live table game.

U.S. Pat. No. 5,809,482 (Strisower et al.) and U.S. Pat. No. 5,586,936 (Bennett et al.) describe methods for tracking players located at each gaming table, which employ a wireless communications network between each table and a host computer. U.S. Pat. No. 5,809,482 teaches a system including a casino database, which stores betting summary records for each of the players and the player's betting rating. In this patent, one or more gaming tables include a plurality of player's positions and a plurality of code readers. The code reader initiates a betting session in response to reading a player identification card encoded with a player identification code. This patent also collects real time data of the player's betting transactions, including the player's identification code and an average bet by the player during the betting session; updates the betting summary record with the collected real time data for the player; and provides the updated betting summary record to the casino database via the communications network. Although this patent may manage the betting records for each players and the player's betting rating information, it suffers from a shortcoming that it is difficult to determine the performance of dealers and also accurately check the revenue for each table. U.S. Pat. No. 5,809,482 also discloses an automated gaming table tracking system which includes a sensor located at a dealer's side for sensing the start and end of each game; an unique player identity card containing identity information of the player assigned to the player identity card; a plurality of player station controls, one of which is located at each of a plurality of player positions; and a central distribution control connected to each player station control for determining the start and the end of each game and beginning and termination of play by each player at each position. Although this patent may check the start and the end of the game and manage information of the player's betting transactions, it suffers from a drawback that it is difficult to determine the performance of each dealer.

All patents and patent applications described herein are incorporated herein by reference in their entirety for all relevant technical disclosure.

As noted above and as evidenced by the quality and quantity of information that can be provided electronically to a central or local facility regarding game activity, the ability of casinos to perform meaningful evaluation or meaning analysis of the data is being exceeded. It would be desirable to provide a system that enables casino personnel to quickly access and interpret data provided to their computers.

It is known in the art to configure data collection systems in the casino industry by providing at least one server and a network of computer systems having access to data on the server or servers. For example, it is known to use Windows-based applications, also known as a thick client computing systems to support data acquisition and control devices, wherein all of the data processing was done at a local PC. Thick client applications have a number of disadvantages. For example, user interfaces for the ITS data display must be installed at every computer it is to be used at. Also, when communication is interrupted between a user and the thick client system, screen information and some data must be reloaded after the communication is reestablished. Each time the software to manipulate the data is upgraded, the upgrades must be installed in all user PC's. Perhaps the biggest disadvantage of a thick client system is that data is only accessible from PC workstations that are loaded with the appropriate software. As software requirements change, it is often necessary to upgrade or replace PC workstations, adding to the cost of accessing information.

It would be desirable to provide a computerized data access and retrieval system that is inexpensive, does not require upgrades and reprogramming, can be accessed by a number of different data acquisition devices without special programming, which is not dependant on the operating system and architecture of the central computer system, and which can be conveniently accessed.

### SUMMARY OF THE INVENTION

A data access and retrieval system enables casino personnel to access remotely stored casino information using a data access and display device via a network connection. A web-browser enabled thin client application runs on a remote server accessible by the network. The server is capable of transmitting web pages and other information to the data access and display device. As the data is retrieved, it is updated and transmitted to the access and display device. Information provided to the casino computer may be requested from multiple files and provided in customized formats at the request of authorized casino personnel. Examples of information requests can include data/records: specific to personnel (e.g., dealers, pit bosses, croupier, security guards, etc.), specific to tables, specific to games, specific to classes of games, to pits, to wagering limits, to shufflers, to roulette wheels, and the like, and the requests can define measures of performance, down time, volume, frequency, and individual round events (e.g., hands in cards or spins in roulette or tosses in craps), etc. The requests can be tailored by casino personnel input to specific time intervals or histories. By providing a user-friendly interface and a wide range of requested data in many possible formats, casino personnel are able to tailor the requests and narrow the fields, and manageably use the data without requiring special software residing on the local access and display device.

### BRIEF DESCRIPTION OF THE FIGURES

FIG. 1 is a schematic diagram of a casino computer network system incorporating a user access and display device of the present invention.

FIG. 2 shows a casino card gaming table having data collection devices.

FIG. 3 shows a state machine diagram of a data acquisition system accessible by the present invention.

FIG. 4 shows a flow chart exemplifying use of technology described herein.

### DETAILED DESCRIPTION OF THE INVENTION

The present invention is a data access and retrieval system that is capable of providing casino personnel ready access to data being collected on the casino floor. The inventors have discovered that using a Web-based access to important data collected on the casino floor provides many advantages that overcome the limitations of thick-client systems, such as standard Windows-based applications. For purposes of this disclosure, the use of a web-based access system to casino data is referred to as a thin client environment.

The proposed application operates as a data access and retrieval interface to the SMI back office (i.e. a network capable of collecting and storing casino data) that serves HTML pages and allows an end user to access the SMI database from any web browser, such as from a PDA, PC or laptop computer or other device equipped with a browser capable of accessing the casino's central computer network or internet network. Casino personnel can reach the database to get reports at any location that has network access. Web-based or thin client-user interfaces are well understood and technically supported within the information technologies industry. As background therefore, the book Thin Clients: Web-Based Client/Server Architecture and Applications; by Dawna Travis Dewire, and D. Travis Dewire, McGraw Hill Publishers, 1998 is incorporated herein by reference, in its entirety. Thin client architecture, which is also referred to in the art as thin client computing, centralized computing, controller based computing and server based computing is architecture that allows a client device to exchange information or receive information with or from a host with minimal processing at the client level. The client processor runs an installed web browser but does not execute application code. The web browser can apply interpreted codes such as JavaScript. The client processor need not have mass storage memory or a powerful processor. The use of thin client computing also allows for the use of a narrower bandwidth of processing power than does thick client computing.

A thin client system can be a low-cost, centrally managed computer devoid of CD-ROM players, diskette drives, and expansion slots. The term derives from the fact that small computers in networks tend to be clients and not servers. Since the idea is to limit the capabilities of these computers to only essential applications, they tend to be purchased and remain “thin” in terms of the client applications they include. In client/server applications, a client is designed to be especially small so that the bulk of the data processing occurs on the server. Although the term “thin client” usually refers to software, it is increasingly used for computers, such as network computers and Net PCs that are designed to serve as the clients for client/server architectures. A thin client may be a network computer without a hard disk drive, whereas a fat client includes a disk drive.

A thin client can alternately be nearly any computer, including one that contains a CD-ROM, diskettes and expansion slots. All that is required is that the client processor contain a web browser in order for the device to function as a “thin client.” One characteristic unique to a “thin client” is that there is no special software installed to use the application program. The application program resides on a remote server. For this reason, a thin client can be used on any operating system. A thin client device does not typically require a storage device of any kind.

A client may be the requesting program or user in a client/server relationship. For example, the user of a Web browser is effectively making client requests for pages from servers all over the Web. The browser itself in this context is a client in its relationship with the computer that is getting and returning the requested HTML file. The computer handling the request and sending back the HTML file is a server.

In information technology, a server is a computer program that provides services to other computer programs in the same or other computers. For example, a database accessible to multiple PC's is commonly referred to as a server program because it serves multiple PC's. The computer that a server program runs in is also frequently referred to as a server. In the client/server programming model, a server is a program that awaits and fulfills requests from client programs in the same or other computers. A given application in a computer may function as a client with requests for services from other programs and also as a server of requests from other programs.

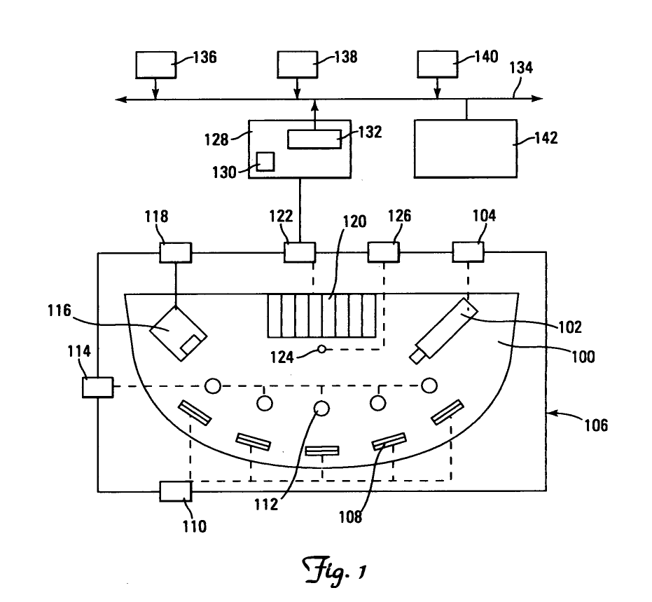

The data access methods and apparatus of the present invention can best be understood by referring to a schematic diagram of a casino-based data acquisition system, network and data access and retrieval system, as shown in FIG. 1. Although the specific types of data being accessed are not important to the invention, an example of a distributed architecture data acquisition system on a live gaming table 100 is illustrated. The gaming table has a card-dispensing device 102 which is capable of counting dispensed cards, reading rank and/or value of cards, providing a display of dispensed cards, and other information important to the house. This card-dispensing device 102 can also be a card shuffler, and may send signals to a processor 104 which in one embodiment is a G-Mod and is capable of broadcasting data over a network 106. Player identification information may be provided when a player inserts a player identification card in a card reader 108, one reader located in each player position. In this example of the invention, all card readers 108 are in communication with a G-Mod 110 that date stamps and sends collected information over the network 106. The table may be equipped with betting sensors 112, each connected to a G-mod 114 dedicated to bet sensing. Additional data acquisition devices such as a card reading discard rack 116 and corresponding G-mod 118, a chip rack reader 120 and corresponding G-mod 122 and a round counting sensor 124 and G-mod 126 may also be provided. All of the data acquisition devices broadcast data over the table network 106 and the time stamped, dated and preferably formatted data is sent to an external computer 128 that serves the function of a server. A database 130 resides on the computer for storing information received over the network 106 from the variety of data acquisition devices.

Also residing on the external computer/server 128 is a HTTP server 134 that is in communication with the casino network 134. The server 134 has the ability to respond to requests from any number of data access and retrieval stations such as a laptop computer 136, a desktop computer 138, a PDF 140, a blackberry wireless device or virtually any external device that has a browser and is in information communication with the network. Examples of web browsers that are suitable for this purpose include Internet Explorer, Netscape, Qtopia, Lynx and many other web browsers. In addition to providing access, it would be desirable to provide a security system to restrict access to casino data. One such system could assign passwords to employees and require the input of the password before any information is retrieved.

Using a web browser such as Internet Explorer, the user can call up a “page” that is typically a HTML file. The Browser will display the file on the access device in a manner that is user friendly and straightforward. Back end software can be provided (using PHP or JAVA programming languages, for example) to format the data in usable form, and provide the client with choices for sorting and compiling the data into meaningful reports.

Although the HTML server is shown as accessible from the casino network, the system could be alternately configured such that the thin client user face server is instead located on the data acquisition network 106. It is preferred that the web browser application remain on the casino network 134 because it is more readily accessible to employees, and possibly the public. Security measures can be implemented to prevent or allow as much access to the casino network 130 as is desired by the house.

The proposed use of a web browser to access stored casino data serves the important function of transferring the manipulation and compilation of data to the server, making it possible to use the access device with any number of server hardware and software architectures. For example, the access device of the present invention is capable of retrieving data from a Linux-based server system as well as a Windows-based server system. In addition, other servers 142 can be connected to the casino network 134 and similarly accessed by the same access device, providing that the proper network communication protocol (such as another HTML server) resides on server 142.

The presently described technology can be a collaboration of two parts, the Front-end and the Back-end. The Front-end means what users see on their monitor such as the reports, pull-down menus, ‘buttons’ and the like that allow users to click on, select and otherwise open new pages etc. Back-end, on the other hand, is what happens behind the scene; it sorts all of the data that is collected from the casino data acquisition systems and converts the data to different types of reports following an authorized user's command.

There are many different programming languages that can be used in developing software. Engineers usually choose the most efficient approach depending on the specifications of the projects' functionality. In this application, the Front-end software has been programmed using PHP together with JAVAScript. The Back-end is been developed using “MicroSoft.Net Programming Environment”, also known as “C#”, and “Crystal Report Engine”.

PHP is a web server development language that delivers a web page to users; it has a significant advantage of not been restricted to any server platform architecture. This flexibility allows application to be used with both Windows and Linux platforms thus broadens the product market. Java Script is also used in the development of front-end applications. It is mainly used to create “buttons” and capability of opening more windows.

The MicroSoft.net programming environment, or C#, is similar to JAVA. It is chosen over other programming languages because of its ability to deliver Crystal Report. Crystal Report is a feature-rich report format that has been widely used in the industry. It quickly transforms data into powerful, dynamic content and tightly integrates reporting functionality into JAVA, .NET and .COM applications, which empower end users with flexible report viewing and interaction capabilities.

As mentioned before, the content and the format of the report are highly customizable. In the process of developing this software, the inventors consulted with various casino managers to learn what types of information are most desirable on the report. Base on the information received from the industry, the inventors created a few pre-designed report formats that includes dealer's efficiency, casino reports, game reports etc. The reports are saved on the server can be sorted by date, shift, games and dealer. Thin client or server-based computing has also been described as Thin-Client Computing (sometimes called “Server-Based Computing”) is a model in which applications (the software that we use day to day) runs on servers, and only the user interface (the windows, controls, cursors and pointers etc) is presented to users via software running on almost any type of computing device (the “Thin-Client” itself). Because the Thin Client only deals with the display (the monitor) and input to request information, (the mouse and keyboard) it uses simple hardware which is less prone to faults and requires very little user expertise.

The differences between Thin-Client and other ways to run applications can be summarized as follows. Most people who have used computers are familiar with business applications like word processors and spreadsheets which run on PCs. Sometimes servers will store the files which people work with and back them up onto a network, but the use of the application relies on the stability and performance of the PC itself. This has led to the well-worn path of upgrades to and replacements of PCs that need to run the latest versions of everyday office applications.

Other core business applications which use shared databases have a similar requirement for the PC to run a large part of the application, even if some of the processing of the database is done by a server or servers. This method of computing is often called “client/server architecture”. “Client/server architecture” performs processing on powerful client devices, called “fat” clients, which in turn need “fat”, expensive connections to the servers so that the typically large amount of data may be passed back and forth.

Another model for computing is “distributed or network computing”, which may be less familiar. In this model parts of the application are dynamically downloaded from a network to the user's client device in order for them to run. This sort of computing also requires a “fat” client for running the software once it has been downloaded. This model will often require “fat” connections to download the application components and the data for the system to function.

Contrary to both models described above, a thin-client architecture keeps all the work of running applications on the servers. Almost any device may be used to connect to, and use the servers' applications, and the minimum required will almost always be considerably less expensive than its nearest “fat” counterpart. Thin client computing leads to considerable cost of ownership savings through centralized management, the ability to leverage existing computer infrastructure, and the option to use inexpensive, thin clients and narrow bandwidth connections.

Citrix Corporation provides an application server computing capability that uses a central technology called Independent Computing Architecture (“ICA”). ICA is a remote presentation services protocol that provides the foundation for turning many different types of user devices into a thin client. ICA consists of a server software component, a network protocol component, and a client software component. The following are features of ICA:
Server. ICA separates an application's logic from its user interface. The application executes entirely on the server, and only the user interface is actually transmitted to users. For this reason, Application Service is able to centralize all system, application and user management on the server for greater efficiency and lower cost of ownership.
Network. ICA enables an application's user interface, as well as keystrokes and mouse movements, to be transported to and from the client over standard network protocols such as TCP/IP, and over network connections such as dial-up, ISDN, ADSL and DDS. With thin client architecture, applications require only a fraction of the network bandwidth of a client/server model. Therefore, ICA allows the latest, most powerful applications to be transmitted rapidly over standard networks.
Client. By centralizing application processing on the server, ICA turns many different types of user devices into a thin client that only needs to be able to display and manipulate the user interface. The specific memory, features and brand of the device are irrelevant. ICA supports a wide array of devices, including Windows Based Terminals as well as traditional PCs and workstations.

This application is currently designed to support Windows Server since most casinos use a Window server platform. It is possible to be used with other server platforms such as Linux, UNIX, MAC OS and the like, with only minor program modifications.

A concept of operative control among processing units should be appreciated to appreciate the performance of the present invention as well as to comprehend differences between the practice of the present invention and conventional processing apparatus used in the gaming industry. The most important concept is that all existing systems perform by a single main processor sending commands to peripherals (such as data acquisition devices) to perform specific functions. For purposes of discussion, the initial main emphasis of the description will be directed towards the performance of a casino table card game gaming apparatus. This emphasis is not intended to narrow the scope of the invention, but is rather intended to simplify the description.

The systems in live gaming table systems tend to be structured in the same manner as the slave master-formats of slot machine devices, with systems described as comprising a main computer, central computer or the like, and various peripherals such as card readers, chip readers, cameras, lighting elements, shufflers, bet sensors, movement sensors, motion sensors, jackpot incrementers/decrementers, game status indicators (e.g., jackpot registers, blackjack indicators, symbol indicators and the like) and any other elements of the table game.

Other control structures are possible. For instance, preferred decentralized control structures such as those described in co-pending applications Ser. No. 10/880,410 and Ser. No. 10/880,408, both filed Jun. 28, 2004 describe the use of multiple intelligent data collection modules, each acting as finite state machines. The content of these disclosures is hereby incorporated in their entirety by reference. Each module is communicatively interconnected with at least one of a shuffling apparatus (e.g., playing card shuffling or randomizing apparatus), bet sensor and “Semi-Smart” delivery shoe or card receiving shoe to collect data, date stamp the data and send it to a central data repository via a network. The processing unit, referred to in this application in one example within the generic scope of the present disclosure, as a “G-Mod” is a microprocessor with associated memory that is capable of being programmed. In another form, the G-Mod is a hard-wired as a FPGA (field programmable gated array). The G-Mod performs data acquisition; date stamps and sends sensed data via a network such as an Ethernet to an external computer that contains a database. In contrast to systems that provide an exclusive main computer to command all or most individual sensors and peripherals, in the presently described technology, the G-Mod's detect activity in the sensors and peripherals. The G-Mod's date stamp and broadcast the information over an Ethernet to a central database. One preferred mode of communication is UDP but others such as TCP, TCP/IP and Zigbee Mesh Networking are alternate communication protocols. In a preferred form of the invention, the G-Mod's broadcast information over a network but do not issue commands to other G-Mod's. Less powerful techniques (as compared to typical main processor systems used in gaming apparatus) may be distributed to monitor each peripheral. The use of these separate intelligences for each peripheral eliminates the need to reprogram old modules as new modules are added, and allows the manufacturer to offer customized hardware and software packages capable of collecting only the information that the casino operator wants to collect.

Casino table card games can be provided with a wide variety of sensors. One such sensor is for detection of an event that indicates approximate beginning or final completion of a round of play of a casino table card game. The sensor 124 (FIG. 1) is read by the distributed intelligence table subcomponent (a G-Mod) 126 that has a time/dating capability. The signal is time/date stamped (referred to herein as “Date Stamping” or “date stamping” for simplicity. The date stamped data is then transmitted generally through a communication line 106 to an external computer 128 that contains database management software and a database interface. The data can be accessed by programs used to analyze the data, if needed. The database interface allows casino management to extract the data in a usable form. The collected data retains its date stamping at least through storage, analysis, data entry or other treatment of the data after transmission away from the table, and the date stamping is typically provided by the separate intelligence, although in some cases may or may not be provided by the sensor itself.

As already noted, the initiating event that occurs which becomes a basis for a signal indicating a round of play in a game comes at least from one of three elements on a casino gaming table environment. The three elements according to the described technology include at least a playing card shuffling device, at least one bet sensor, and at least one card delivery or card discard receiving device. As these devices may have multiple events occur during their use in a single round of play, the event selected for providing the signal or the initiation of the signal should be sufficiently unique during the operation of the element as to clearly indicate a round count event.

For example, in the use of a playing card delivery tray or a shuffler, there are numerous events that may be repeated. With a delivery tray, removal of individual cards occurs repeatedly, and every card removal could not be used to indicate a round. Similarly with a shuffler, each round would include at least one shuffling-type activity, usually multiple shuffling-type activities (such as separation of a first group of cards into separate sections, elevator movement, card movement from the first group of cards to be shuffled, rotation of a carousel or fan, ejection of cards from a first set of cards to be randomized, counting or identifying of cards, counting card totals, etc.), and so particular events must be identified in the shuffler activity that would be used for round counting event notification. There are numerous activities from which events could be selected. It is also possible that there is a dealer input system (e.g., button, panel, touch screen, voice activation, etc.), although this again brings dealer activity and dealer attention into the signal, while an automatic signal is preferred.

For each of the devices, non-limiting examples of the types of occurring events will be discussed to provide a basis of considering those events for selection or at least analysis of the many other occurring events from among which one or a combination of events may be programmed or selected to provide the round counting signal event.

In a shuffling device, one simple way of determining a count of rounds and providing a signal that will be the event basis for sending a signal or command to send a signal could be a “Start Shuffling” signal. This is not merely an on/off switch event, but rather (in a batch shuffler), any action that initiates a beginning shuffling sequence for a full set of cards (e.g., one deck, multiple decks) to be shuffled. In certain shufflers, this signal is sent when a deck(s) is inserted is inserted into a card receiving area. The shuffler then automatically begins a complete shuffling sequence. In some shufflers there is an additional advantage to the selection of this internal shuffler signal as the round-counting starting event, and that is the fact that the actual dealing of a round of cards is allowed only when a first set of playing cards has been randomized and a second set of playing cards inserted into the shuffler. Therefore, there may be no lag in round counting as the system can be programmed to initiate a round count signal upon the first occurrence of the second set being inserted into the shuffler, and then every subsequent round count event will be the insertion of any next set of cards. The actual rounds dealt will then correspond more literally with the actual count provided.

Another event on certain formats of shufflers that can provide a sufficiently unique event as to provide a reliable round counting event is a batch shuffler where partial hands (in excess of single cards) or complete hands are provided to players or to players and dealers or to players and community sets of playing cards. A unique event in the round operation of such a shuffler would include a first hand being dealt to any player, a dealer hand being dealt, community cards being dealt, surplus cards being provided to the delivery tray, or combinations of these events. In the operation of the hand-providing shufflers, different designer choices may suggest the benefits of one event versus another, but with intelligent control and programming of the system, there should be numerous events from which to select the event that will trigger the round count signal from a shuffler. In some shuffler systems there are doors that are opened or closed for removal of randomized sets of playing cards or for insertion of unrandomized cards. The movement of these doors, especially where door movement is automatically performed by the shuffler apparatus, provides a good round counting event to trigger a signal. Events such as a jam signal could also be used to send a non-round count signal or subtract round count signal if a round count signal had been sent during that shuffling cycle.

In a card discard receiving rack, other distinct events could be programmed or designed to provide a unique round counting signal. Where discard racks are used to verify a deck or set of cards (that is all playing cards placed into the discard rack are counted (to verify a total number of playing cards) or counted and read (to verify a specific set of a particular number of playing cards), the occurrence of a verified set signal, the combination of cards inserted with the absence of an alarm signal, and the like could be used to trigger the round count signal. In a continuous shuffler system used with a card discard rack, the insertion of any set or group of cards into the playing card discard rack could be an effective event. This could be easily performed by awaiting until all hands at the table have been played, with cards from intermediate events ending the play of individual hands (e.g., a player busting) being stored in an intermediate receiving area, and then when all cards (including dealer cards) have been collected, the insertion of all cards from that round inserted into the card receiver. In that case, the single event of placing a set of cards into the card receiver would uniquely trigger an accurate round counting event to provide the round count signal.

In the use of the bet sensor(s) to automatically provide a unique event signal that can be used to provide a signal regarding the count of a round of play, there are again options for providing the round count signal from a unique event performed by or on the sensors. In some sensor systems, there is a lockout mechanism performed by the dealer on bonus wagers (e.g., in Caribbean Stud® poker, Let It Ride® stud poker, etc.), so that when the lockout step (preventing further wagers) is electronically or mechanically effected, a signal could be sent that a round has been played. When bet sensors are under the table, a change from “Bets Present” to “All Best Removed” sensed by the sensors would be a unique event signaling the end of one round, and a signal would be sent. Again, the designer has to select an event that cannot be misinterpreted as anything other than a unique event during a round of play before sending a round count signal.

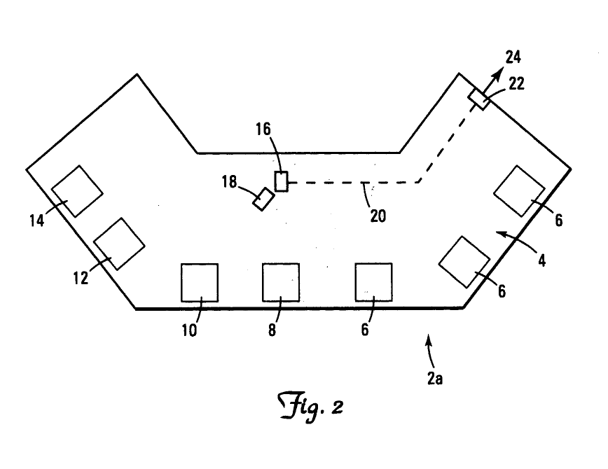

FIG. 2 shows a casino card gaming table 2. The table 2a has a surface 4 with seven player positions 6 (three positions labeled 6, 8, 10, 12 and 14 thereon. A hand sensor 16 is provided for the dealer cards 18. The sensor 16 is connected by a communication system (preferably a wire system, but RF or other wireless systems could be used) to a finite state machine 22 for the table 2a. The finite state machine 22 is on a communication line 24 to a data collector (not shown). Also shown are seven bet sensors 30 (including three identified as 30a, 30b and 30c, for later reasons), a shuffler 36, a discard rack or receiving tray 38, and a set of communication of systems 32, 34, 40 and 42 (which again may be wired, wireless, RF, infrared, etc.). Just as explained below for the operation of the hand sensor 16, the unique round counting events in any of the bet sensors 30, the shuffler 36 or the discard tray 38 will enable or cause the round count signal to be sent, either to a G-Mod, microprocessor, table processor, central processor or the like, as described herein. Bet sensor 30a is shown with a potentially direct line 44 communication systems to a microprocessor 24. Bet sensors 30b and 30c share a communication line 34.

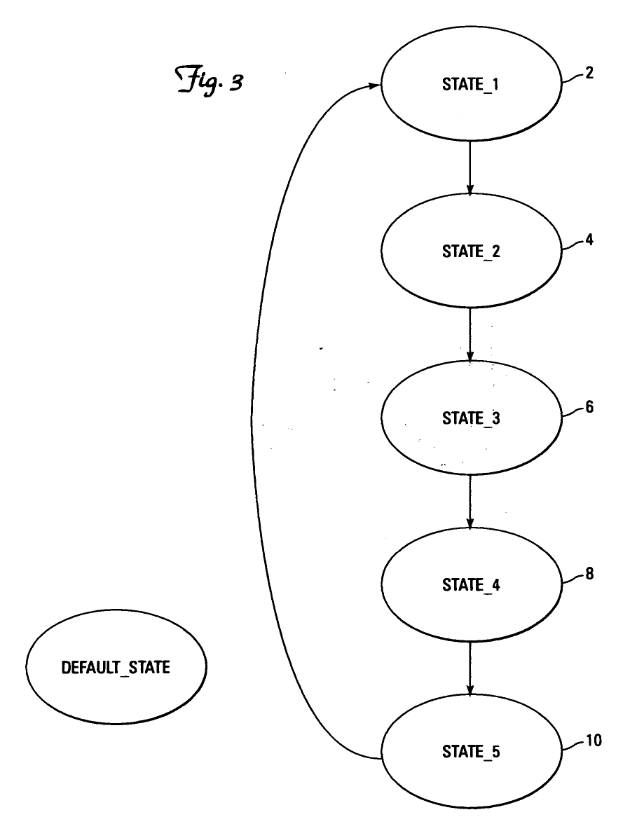

FIG. 3 is a diagram of a representative finite state machine that is part of a distributed architecture data acquisition system that can collect data accessible by the web-based network data acquisition and display method and apparatus of the present invention. The arrows in the figures represent triggering events. Each state typically has attributes associated with the state (such as bet sensor on, for example) and methods invoked at transitions or during a state. The finite state machine initially remains in an idle condition 2. It waits for a triggering event, such as the receipt of a signal from a bet detection device. In a first state 2, the bet detection device is active but is not sensing the presence of a wager. When the wager is placed, the bet present sensor senses the presence of a wager 4. The receipt of the data causes the data to become encoded 6, and then transmitted 8 to the remote database, where the information is stored. Once the transmission is complete and the communication ceases 10, and the finite state machine returns to its idle condition 2.

As noted above, there are many different elements of the gaming system that can be considered as peripherals and/or data acquisition devices. Some more important examples of table-game related peripherals include: bet presence, bet recognition, bet separation, card identification, card tracking, player tracking and employee tracking. Other components might include (in addition to those described above) multimedia processing, stepper motor control, random number generation, I/O detection and response, audio signals, video signals, currency handling, coin acceptors, bill acceptors, paperless transactions, ticket-in and ticket-out crediting, security systems, player accounting functions, door locks, shuffler function, card readers, discard rack function, chip tray inventory, signal lighting (change/assistance), player input (e.g., button controls, joy sticks, touch screens, etc.) and any other functions that my be provided on the gaming apparatus.

The units (which may be elsewhere referred to herein as gaming modules or G-Mod's) are operated substantially independently of each other, although some interdependencies could exist. In the event of interdependencies, they are not subject to the classic control model but operate by finite state machine changes that are broadcast and then react with intelligence. For purposes of this disclosure, the term “finite state machine” (hereinafter a FSM) is a theoretical device used to describe the evolution of an object's condition based on its current state (or condition) and outside influences. The present state of an object, its history, and the forces acting upon it can be analyzed to determine the future state of an object. Each state then may have a “behavior” associated with it. An FSM is a very efficient way to model sequencing circuits. Ultimately the game is nothing more than a complex sequencing unit, branched as appropriate for the game function. All finite state machines can be implemented as hardware logic circuits, software running on a processor or combinations of the two.

By assigning specific data collection controls to local architecture, the design of the system places system tasks into lower computing power manageable units. The manageable units (e.g., the peripherals) can then be each handled (or small groups handled) by dedicated controller modules. Some design care should be taken to combine control of peripherals under a single intelligence to assure that such accumulating demands for processing power are not being required as to merely reconstruct a main processor in a different physical location with the system. For example, it makes sense to combine the tower light (change/assistance) light command control intelligence with other button control signals, even though the result is not a game play function. The intelligence requirement for such an assistance function is so low that its addition to almost any other function would be barely noticed. In the distributed intelligence structure, the G-Mod's or individual intelligences have enough intelligence on board to handle the details of how the G-Mod itself handles the details of operation of the peripheral device.

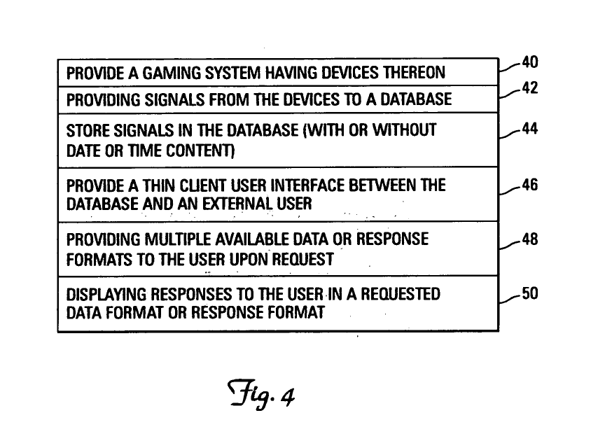

As shown in FIG. 4, the method of the present invention includes the steps of providing a gaming system having devices thereon 40; providing signals from the devices to a database 42, storing signals on the database representative of data received from the devices 44, providing a thin client user interface for accessing the database from a network 46, providing multiple formats to the user on request 48, and displaying responses to user requests in the correct format 50. Although the present invention has been described largely in terms of accessing a statistical data base or analytical data base, to which at least some data may have been provided by at least one distributed architecture component, and where individual modules may be available that send date-stamped information to the central database, it is to be understood that multiple modules could be present in one system to send collected data to a data repository, which may then operate in the client-server or thin client format. In a preferred embodiment, the data stamped data is broadcasted over an Ethernet specific to the table game, and that the data in this format is collected and recorded by the central data repository. The central data repository resides on a server, that is accessible from the access device via a casino network or other network such as the World Wide Web (internet).

Although not limited to the following list and compilation of formats and requests that may be used to seek information from the casino data base in thin client format, the following list will at least be instructional in some of the variables and benefits that can be provided according to the presently described technology.

One or more sensors could sense information transmitted through an output data port of a shuffler, for example, or a keypad control used to issue commands to a shuffler. The shuffler would have it's own G-Mod and is capable of transmitting date stamped information such as number of cards per hand, number of hands per hour, number of cards dispensed per unit time, number of cards re-fed into a continuous shuffler per unit of time, number of promotional cards dispensed per unit of time, etc. Or, the microprocessor within the shuffler can be programmed to function as a G-Mod. At the same time, another indicator attached to a G-Mod could transmit data stamped data about bonus awards granted at a certain time, and the like. This information could be collected in a central database.

A bet interface module could also be provided. Known collection techniques for wagering data include optical and metal detection type bet present sensors for fixed bets, and camera imaging, radio frequency/identification technology, bar code scanning, scene digitizing, laser scanning, magnetic strip reading and the like for measuring the amount of the bet, as well as the presence of the bet. Outputs from these measurement devices are fed through a dedicated G-Mod and the data is date stamped and delivered to the central data depository.

Another possible G-Mod controls a card-reading camera, chip reading camera or other sensing device with similar functionality (reading rank and suit of a card, or just rank) located in the card shuffler, the dealing shoe, and the discard tray, above the table or combinations of the above. Information about the specific cards dealt to each player could be obtained from the database by first feeding date-stamped information about cards dealt and returned into the database via the Ethernet.

In one form of the invention, the G-Mod sends date-stamped information to the database and an algorithm residing in the same computer or separate computer uses this information as well as round counting and betting information to determine the composition of a hand of blackjack, for example.

Another G-Mod is in communication with an identification (i.d.) system for tracking the movement of employees in and out of the pit, or more preferably when the dealers arrive at and leave the table. This information is collected and reported by the dealer G-Mod into the database, and then reports can be generated that combine this information with rounds of play per hour to determine which dealers deal the most hands in a given period of time.

In a roulette application, a sensor and associated G-Mod can record the number of spins of the wheel in a unit of time, for example. This information could be associated with the player swipe card information from another G-Mod by merely comparing the time stamping of the data to determine how long a particular player stayed at a table.

It is important to note that in a preferred form of the invention, all of the G-Mod's are in communication with the same database. Also, the data repository does not issue commands to the G-Mod's, with the exception of requesting configuration data and resetting/rebooting the G-Mod's. The central database merely organizes the data in a manner that allows for easy access by external computers or another application programs residing on the same computer or elsewhere on the network. In this respect, the G-Mod's are self-executing and do not require central intelligence to perform their individual functions. The data may be analyzed and used to make decisions about awarding redeemable points and free rooms to players, etc., scheduling pit labor, promoting pit personnel, closing and opening tables, determining optimal betting limits for given periods of time and other important managerial functions.

Each G-Mod may be in data communication with an interface device such as one or more specialized circuit boards to allow the data from multiple G-Mod's to be fed into a standard port of the computer that serves as the data repository. Also, multiple sensing modules may be fed into a single G-Mod if the particular G-Mod has the capacity to process the extra information.

A software interface can be provided to directly access data in the data repository and to manipulate and organize the data so that it can be outputted onto a display, written report or formed into a data stream so that the data can be further manipulated. In one example of a software interface program, the operator can obtain reports of rounds of play per hour per actual table, per pit, or per property, as determined by the user.

The information in the form of a data stream may be further analyzed. In one example, the data is fed into a host computer or can be analyzed in the same computer system where the database and interface resides or on a host computer. For example, the data from one or more of the round counting module, the shoe sensor, the card swipe, card reading module, the shuffler data port sensor, and the bet interfaces can be used to create a report of rounds played per unit of time, the number of players at the table per unit of time, the number of hands played at each round, the maximum bet per player in a given unit of time, the average bet per player in a unit of time, the number of shuffles per unit of time, the number of cards removed from and placed into the shuffler in a unit of time, hand composition and other information considered important to the casino manager.

Because all of the G-Mod's work independently, the casino operator can choose the modules and resulting data that is most important to them for a given environment, and only purchase those modules. For example, one casino might want to reconstruct individual hands, track betting and associate the information with a particular player on a high stakes table, while tracking only rounds and the identification of the employees on low-stakes games.

By using a modular approach to intelligent data collection, only the equipment and reports that are wanted can be provided at the lowest possible cost. Since none of the G-Mod's is issuing direct commands to one-another, it is not necessary to rewrite any code when additional modules are added.

Applicants have discovered that there are potential inaccuracies in data that are transmitted prior to date/time stamping. When signals are stamped in by the main computer, this is merely indicative of when the signal arrived. Also by providing the stamping function at the receipt site (such as the main processor, or central gaming location), the information is more easily subject to manipulation or change by an operator. Also, when there is a line breakdown (e.g., some casinos may still use telephone line connections which can be busy or interrupted, or the communication system to the main computer breaks down), the accuracy of the stamping is adversely affected. The value of the data decreases in some necessary transactions and casino oversight if the time data is inaccurate. A gaming system with different architectural structure and informational structure would be desirable if it could reduce these issues.

The system described herein might well operate on the basis of the individual datum or collective data being forwarded from various sources, including the distributed architecture or G-Mod's or from microprocessors or by traditional direct feed methods through hardwire or wireless connections to a data storage elements. Casino personnel with authorized access (this would require only standard security access, but any level of desirable security may be provided, without limit) to the data storage system would then access the data through a thin client user interface, and would not need specially downloaded software to access the database. Operating on compatible operating systems would be sufficient, as known in the art for communicating on a client server or thin client communication basis.

The user would access the screen (e.g., comparable to the display of an interactive website) through the thin client computing system, and then format the requested information, usually through file icons that are provided on the system, or with a sophisticated user, through keystroke definition of parameters within the database.

A first screen that is accessed might include a list of countries or cities or casinos available for reviewing information in the database. After the field of analysis has been limited (e.g., by icon or file name) by user selection, another set of files will become available. For example, the files may include fields of wagering (e.g., sports book, casino tables, video machines, keno, card tables, mechanical slots, tournament play, internet play, room to casino play, and the like), personnel information, player information, general activity or wagering information, component operation (e.g., shuffler performance, chip counter performance, progressive jackpot performance, and the like), and any other information that is provided into the database. Even such peripheral information such as the number of drinks served to individual players (input by cocktail waitresses or security personnel), credit offered and accepted, ATM usage, player comp activity, etc., may be generally accessed in the thin client computer environment.

Once this general field has been identified by the authorized casino personnel user, narrower parameters may be set up for receiving specific information. Field boxes on the screen may be filled (e.g., Day, ______ year, ______, time from ______ to ______, may be available fields of search; or Employee No. ______; or Table No. ______; or Pit No. ______; or the like) to identify a field of information retrieval sought. Combined searches such as a specific employee at a specific game (e.g., records regarding activity of Employee No. 079836 at Blackjack between the hours of 10 p.m. and 2 a.m. on Saturdays and Sundays can be searched to determine if there is an unusual play procedure that occurs in that field). When that field is chosen, other fields may be chosen or additional information or comparisons made, such as requesting a comparison of losses at table on Saturday nights between 10 p.m. and 2 a.m. at all blackjack tables, and listing those tables in order of greatest loss or least loss. The field may then be expanded to include all Saturdays for three months, and a listing of all information on magnitude of losses according to dealers another search parameter. All of this information is available in the database, which is now being accessed through a thin client user interface.

The fields that may be established for access through the thin client interface are essentially unlimited, and the processing is done at the database site, information retrieval is at the database site, and no special software (other than a compatible operating system) is needed on the user interface through the thin client user interface system. This even enables the potential for any home PC, any non-processing monitor and keyboard, PDA, Blackberry, and the like to access the database with proper-authorization. It is therefore possible for central location of personnel for security operations at a location that is distant from the casinos (e.g., a home in Montana may be able to simultaneously oversee data from casinos in Bermuda, Las Vegas, and Mississippi). Individuals may work at home or abroad, and be able to have complete and secure file access for operations. Specialists in distal locations may be patched into the thin client interface system and the information shared for analysis.

Although specific examples of hardware, software, file names, icons, comparative bases and the like have been used in the descriptions and the examples, these specific examples are not intended to be limiting with respect to the generic practices of technology that have been described herein.

What is claimed:

1. A casino gaming system comprising:
at least one gaming data collection device; ;an information transmission device integral or proximate to the gaming data collection device that provides a signal that is indicative of a state of the device in the gaming system or indicative of data obtained from that device and sends the information to a database,
a database that receives and stores information from the gaming data collection device, wherein the database is accessible via a network; and
a thin client user interface server enabling a network communication link between a user on the thin client user interface and the database.

2. The system of claim 1 wherein an authorization system exists in the thin client user interface enabling only an authorized user to establish communication with the database.

3. The system of claim 1 wherein icons are provided on a user screen to the client user that enables the user to define fields from within which information is sought.

4. The system of claim 1 wherein interactive search fields are provided on a user screen to the client user that enables the user to define fields from within which information is sought.

5. The system of claim 1 wherein at least some data in the database comprises at least one set of data relating to at least one of wagering information, apparatus performance, table activity, game activity, personnel performance, slot performance, losses at individual tables, winnings at individual tables, losses by individual players, winnings by individual players, dealer location, information provided on a date stamped basis, and cashier activity.

6. The system of claim 1 wherein the at least one gaming data collection device is selected from the group consisting of at least one bet sensor, playing card shuffler, an intelligent playing card delivery shoe and an intelligent discard rack that senses activity that causes a signal to originate in the device and further comprising an intelligent data collection module that senses signal changes in output from the at least one gaming data collection device, the intelligent module acting as a finite state machine capable of date stamping the data and transmitting the date stamped data to a database over the network.

7. The system of claim 6 wherein the gaming data collection device is a playing card shuffling device.

8. The system of claim 6 wherein the gaming data collection device is a bet sensor.

9. The system of claim 1 wherein the signal from the gaming data collection device is sent by an RFID circuit.

10. The system of claim 1 wherein the signal from the gaming data collection device is sent via at least one of a hard wire connection and a mesh network.

11. The system of claim 1 wherein the client user cannot add information to the database through the thin client user interface.

12. The system of claim 6 wherein the intelligent data collection module comprises a chipboard.

13. The system of claim 6 wherein the data collection module does not store signals or data contained in the signals after date stamping and forwarding the signals.

14. The system of claim 7 wherein the shuffler provides individual hands or partial hands of playing cards to be manually withdrawn from the shuffler by a dealer.

15. The system of claim 6 wherein the database that receives and stores collected information is transmitted at least in part via an Ethernet.

16. The system of claim 1 wherein the communication over the network is performed by a method selected from the group comprising UDP and TCP.

17. A method of interfacing with data collected from a casino gaming component comprising:
providing at least one gaming component;
providing at least one device on or proximate to the gaming component that provides a signal that is indicative of a state of the component in the gaming system or indicative of data obtained from that device,
a database that receives and stores information from the device or component, and
a thin client user interface enabling a network communication link between the thin client user interface and the database.

18. The method of claim 17 comprising providing at least one intelligent controller dedicated to collecting information from at least one device;
the intelligent controller receiving a signal relating to a state of the at least one device;
the intelligent controller date and/or time stamping data collected from the at least one device;
the intelligent controller broadcasting the date and/or time stamped data over a network; and
recording the broadcasted information in the database.

19. The method of claim 17 wherein the database receives date stamped signals over a period of time and upon request by a thin client upon to display a field of information containing a time component over a period of time, the period of time is based at least in part upon use of the date stamping received.

20. The method of claim 19 wherein the original signal from the device contains no indication of date or time thereon.

21. The method of claim 18 wherein the signal is provided by a playing card shuffling device.

22. The method of claim 18 wherein the signal is provided by at least one bet detector.

23. The method of claim 18 wherein the signal is provided by a playing card delivery tray.

24. The system of claim 1, wherein data transmitted from the at least one gaming collection device is communicated over a network to the database.

25. The system of claim 1, and further comprising at least one G-Mod for transmitting state and/or data over a network to the database.

26. The system of claim 1, wherein the database resides on a server, and a network server also resides on the server.

27. The system of claim 26, wherein the network server is a HTTP server.

28. The system of claim 1, wherein the thin client user interface comprises a web browser.

29. The system of claim 28, wherein the web browser calls a HTML file from the server.

30. The system of claim 29, wherein the HTML software enables at least one of the following: the formatting of data, the selection of data, the arrangement of data, and the sorting of data.
